(19) United States
(12) Patent Application Publication
(10) Pub. No.: US 2011/0258187 A1
(43) Pub. Date: Oct. 20, 2011

(54) Relevance-Based Open Source Intelligence (OSINT) Collection

(75) Inventors: Anthony J. DelRocco, Clearwater, FL (US); Sally A. Chambless, Redington Beach, FL (US)

(73) Assignee: Raytheon Company, Waltham, MA (US)

(21) Appl. No.: 12/760,068

(22) Filed: Apr. 14, 2010

(51) Int. Cl. G06F 17/30

(52) U.S. Cl. 707/728; 707/E17.014

(57) ABSTRACT

In certain embodiments, a method for relevance-based open source intelligence (OSINT) collection includes accessing a request for information, determining a first data source associated with the request, and accessing a first data set collected from the first data source by a data collection component. The method further includes applying natural language processing to the first data set to generate a processed first data set and determining an aggregate relevance score associated with the first data source. The aggregate relevance is determined by determining a number of individual relevance scores associated with the first data source and aggregating the individual relevance scores. Each individual relevance score is determined based on a comparison of the processed first data set and a corresponding relevance criterion of a number of relevance criteria. The method further includes storing the aggregate relevance score associated with the first data source.

### TECHNICAL FIELD

This invention relates generally to computer systems and more particularly to relevance-based open source intelligence (OSINT) collection.

### BACKGROUND

OSINT relates to the collection of information from overt, publicly available information sources. Publicly available information sources may include, for example, electronic sources that are accessible via the Internet. Information sources accessible via the Internet may include media websites (e.g., newspaper, magazine, and other news websites), web-based communities having user-generated content (e.g., social-networking websites, video sharing websites, wikis, blogs, etc.), and other publicly available websites. Once collected, the publicly available information may be analyzed to produce actionable intelligence.

### SUMMARY

According to the present invention, disadvantages and problems associated with previous techniques for OSINT collection may be reduced or eliminated.

In certain embodiments, a method for relevance-based OSINT collection includes accessing a request for information, determining a first data source associated with the request, and accessing a first data set collected from the first data source by a data collection component. The method further includes applying natural language processing to the first data set to generate a processed first data set and determining an aggregate relevance score associated with the first data source. The aggregate relevance is determined by determining a number of individual relevance scores associated with the first data source and aggregating the individual relevance scores. Each individual relevance score is determined based on a comparison of the processed first data set and a corresponding relevance criterion of a number of relevance criteria. The method further includes storing the aggregate relevance score associated with the first data source.

Certain embodiments of the present invention may provide one or more technical advantages. For example, because certain embodiments process collected information using natural language processing (NLP) and analyze the processed information using multi-parameter relevance scoring, the results of a request for information may be displayed such that information most likely to be relevant to the user (taking into account contextual and semantic meaning of terms within the collected information) is displayed first (or in an otherwise prominent manner). Furthermore, the relevance scores associated with data sources from which information is collected in response to a particular request for information may be stored such that they can be used to determine the data sources from which information should be collected in response to future requests for information. This use of past relevance scores may facilitate the collection of information from those sources (and potentially only those sources) most relevant to a received request for information. As a result, the collection of massive amounts of irrelevant data may be reduced or eliminated, thereby reducing the time it takes to process the information request.

Certain embodiments of the present invention may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates an example system for relevance-based OSINT collection, according to certain embodiments of the present invention;

FIG. 2 illustrates an example method for relevance-based OSINT collection, according to certain embodiments of the present invention; and

FIG. 3 illustrates example functions performed by certain components of the system illustrated in FIG. 1 during OSINT intelligence collection, according to certain embodiments of the present invention.

### DESCRIPTION OF EXAMPLE EMBODIMENTS

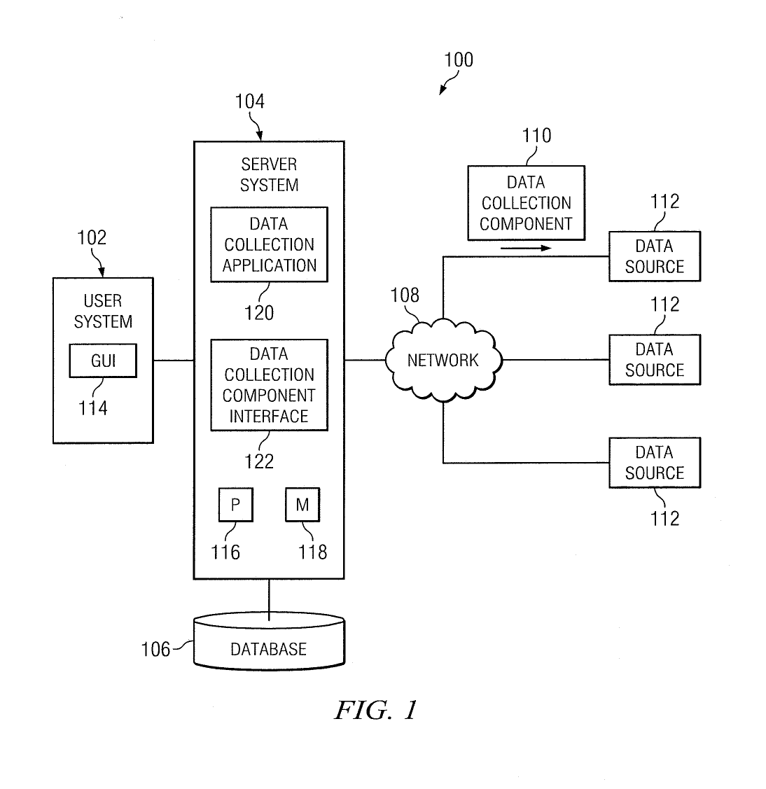

FIG. 1 illustrates an example system 100 for relevance-based OSINT collection, according to certain embodiments of the present invention. System 100 may include one or more user systems 102, one or more server systems 104, one or more databases 106, and a network 108. System 100 may further include one or more data collection components 110 each operable to collect data from a number of data sources 112 accessible via network 108. Although this particular implementation of system 100 is illustrated and primarily described, the present invention contemplates any suitable implementation of system 100 according to particular needs. In general, system 100 is operable to collect (via data collection component 110) a set of information (e.g., web page content) from a particular data source 112 (e.g., a web page) accessible via network 108. System 100 is further operable to apply NLP to the collected data set such that an aggregate relevance score associated with the particular data source may be determined (e.g., based on a comparison of the processed data collected from the data source with each of a number of relevance criterion). The data collection component 110 may then be directed to a next data source 112 such that a next data set may be collected, an aggregate score associated with the next data source determined, and so on until the data collection process is terminated. Accordingly, system 100 may facilitate the collection of data from data sources likely to yield information responsive to a request for information submitted by a user of a user system 102.

User systems 102 may include one or more computer systems at one or more locations. Each computer system may include any appropriate input devices (such as a keypad, touch screen, mouse, or other device that can accept information), output devices, mass storage media, or other suitable components for receiving, processing, storing, and communicating data. Both the input device and output device may include fixed or removable storage media such as a magnetic computer disk, CD-ROM, or other suitable media to both receive input from and provide output to a user of user system 102. Each computer system may include a personal computer, workstation, network computer, kiosk, wireless data port, personal data assistant (PDA), one or more processors within these or other devices, or any other suitable processing device. In short, user system 102 may include any suitable combination of software, firmware, and hardware.

For simplicity, the one or more user systems 102 are referred to throughout this description primarily in the singular. “User system 102” and “user of user system 102” may be used interchangeably.

User systems 102 may each include one or more processing modules and one or more memory modules. A processing module of a user systems 102 may include one or more microprocessors, controllers, or any other suitable computing devices or resources. Additionally, a processing module of a user system 102 may work, either alone or with other components of system 100, to provide a portion or all of the functionality of system 100 described herein. A memory module of a user system 102 may take the form of volatile or non-volatile memory including, without limitation, magnetic media, optical media, random access memory (RAM), read-only memory (ROM), removable media, or any other suitable memory component.

In certain embodiments, user system 102 may include a graphical user interface (GUI) 114 that allows a user of user system 102 to interact with user system 102 and/or other components of system 100. GUI 114 may be delivered using an online portal or hypertext mark-up language (HTML) pages for display and data capture. For example, GUI 114 may allow user system 102 to interact with components of server system 104 (e.g., data collection application 120 and/or data collection component interface 122, each of which are described in more detail below). As a particular example, a portion or all of GUI 114 may include a web browser.

User system 102 may be communicatively coupled (e.g., via a network facilitating wireless or wireline communication) to one or more server systems 104 (referred to primarily in the singular throughout the remainder of this description for simplicity). Server system 104 may include one or more electronic computing devices operable to receive, transmit, process, and store data associated with system 100. For example, server system 104 may include one or more general-purpose PCs, Macintoshes, workstations, Unix-based computers, server computers, one or more server pools, or any other suitable devices. In short, server system 104 may include any suitable combination of software, firmware, and hardware. Although referred to as a “server system,” the present invention contemplates server system 104 comprising any suitable type of processing device or devices.

Server system 104 may include one or more processing modules 116 and one or more memory modules 118, each referred to primarily in the singular throughout the remainder of this description. Processing module 116 may include one or more microprocessors, controllers, or any other suitable computing devices or resources. Processing module 116 may work, either alone or with other components of system 100, to provide a portion or all of the functionality of system 100 described herein. Memory module 118 may take the form of volatile or non-volatile memory including, without limitation, magnetic media, optical media, random access memory (RAM), read-only memory (ROM), removable media, or any other suitable memory component.

Server system 104 may be communicatively coupled to a number of data sources 112 via network 108. Network 108 may facilitate wireless or wireline communication. Network 108 may communicate, for example, IP packets, Frame Relay frames, Asynchronous Transfer Mode (ATM) cells, voice, video, data, and other suitable information between network addresses. Network 108 may include one or more local area networks (LANs), radio access networks (RANs), metropolitan area networks (MANs), wide area networks (WANs), all or a portion of the global computer network known as the Internet, and/or any other communication system or systems at one or more locations.

Data sources 112 may include any suitable sources of information accessible via network 108. For example, data sources 112 may include websites, web pages within a websites, databases, documents, images, or any other information sources accessible via network 108, according to particular needs.

Server system 104 may include a data collection application 120 and a data collection component interface 122. Data collection application 120 and data collection component interface 122 may each include any suitable combination of hardware, firmware, and software. Although functionality is described below as being associated with either data collection application 120 or data collection component interface 122, the functionality described below may be combined and provided by a single application/component or divided among any suitable number of applications/components, according to particular needs. Furthermore although data collection application 120 and data collection component interface 122 are each depicted and primarily described as being stored on server system 104, the present invention contemplates each being stored at any suitable location in system 100, according to particular needs.

Data collection application 120 may be operable to access a request for information. For example, a request for information may be received from a user of user system 102. An accessed request for information may include a number of request parameters defining the type of information sought by the user of user system 102 from which the request is received. For example, the request parameters may define the language of the information sought, the timeframe associated with the information sought, an entity related to the information sought, any other information defining the type of information sought, or any other suitable parameters. In certain embodiments, categories of request parameters may be predefined (e.g., language, timeliness, entities, etc.) such that each received request includes one or more parameters in each predefined category (or a subset of the predefined categories). In other words, in such embodiments a user may define the parameters of a request for information by entering a response corresponding to one or more predefined categories of parameters, selecting from a predefined list of responses corresponding to one or more predefined categories of parameters, or otherwise specifying a response corresponding to one or more predefined categories of parameters in any other suitable manner. Although the request for information is primarily described as including particular parameters, the present invention contemplates the request for information having any suitable parameters, according to particular needs.

Data collection application 120 may be operable to determine a first data source 112 from which information responsive to the request for information is to be collected. In embodiments in which the one or more data sources 112 include websites accessible via the Internet, this first website may be referred to as a “seed site.” In certain embodiments, data collection application 120 may determine first data source 112 by comparing the accessed request for information with previous aggregate relevance scores associated with one or more of a number of data sources 112 (e.g., accessed from memory module 118, database 106, or any other suitable location within system 100). The previous aggregate relevance scores may have been determined by data collection application 120 in response to previous requests for information (as described in further detail below) that are the same or similar to the accessed request for information. As a result, first data source 112 may be a data source previously determined to include information responsive to the accessed request for information (e.g., by data collection application 120, as described below), thereby reducing the likelihood that irrelevant information will be collected in response to the request for information.

In certain embodiments, in addition to or as an alternative to determining first data source 112 data by comparing the accessed request for information with previous aggregate relevance scores associated with one or more of a number of data sources 112 (as described above), data collection application 120 may determine first data source 112 based on user input (e.g., the user may specify the first data source), based on the request for information (e.g., the request for information may identify the first data source, which may have been specified by the user), or in any other suitable manner, according to particular needs.

Data collection application 120 may be operable to initiate collection of a data set from the determined first data source 112. For example, data collection application 120 may communicate an identification of the determined first data source 112 to data collection component interface 122 (or work in conjunction with data collection component interface 122 in any other suitable manner). For example, in embodiments in which data sources 112 comprise web pages, the communicated identification of the determined first data source 112 may comprise a URL associated with first data source 112. Data collection component interface 122 may communicate with data collection component 110 (e.g., a web crawler), and data collection component 110 may collect a set of information from the first data source 112. For example, in embodiments in which the first data source is a web page, data collection component 110 may collect a portion or all of the content of the web page.

Data collection application 120 may be operable to receive the data set (e.g., web page content) collected by data collection component 110 from first data source 112 (e.g., a web page). In certain embodiments, data collection application 120 may be operable to store the first data set (e.g., in database 106, memory module 118, or at any other suitable location in system 100). Data collection application 120 may be further operable to process the received first data set using NLP. For example, data collection application 120 may process the first data set using NLP by performing a computational, linguistic analysis (e.g., using dictionaries, rules, pattern matching, etc.) on the data set to generate a processed data set. For example, the processed data set may comprise document enriched metadata associated with the data set. Although data collection application 120 is primarily described as performing particular NLP on the received data set, the present invention contemplates data collection application 120 performing any suitable NLP on the received data set, according to particular needs.

Data collection application 120 may be operable to determine, based on the processed data set (e.g., document enriched metadata corresponding to the content of a web page), an aggregate relevance score associated with the first data source 112 (e.g., a web page). More particularly, data collection application 120 may determine a number of individual relevance scores associated with the first data source 112, each individual relevance score being determined based on a comparison of a particular relevance criterion among a number of relevance criteria with the processed data set. The relevance criteria may be accessed by data collection application 120 (e.g., from database 106, memory module, 118, or any other suitable location in system 100), determined by data collection application 120 (e.g., based on the received request for information), or otherwise accessed/determined in any suitable manner. Data collection application 120 may aggregate the determined individual relevance scores (using a simple summation, a weighted summation, or any other suitable aggregation technique) to determine the aggregate relevance score associated with the first data source 112.

Each determined individual relevance score may reflect the degree to which the processed data set (and, by association, the first data source 112 from which the data set was collected) corresponds to the relevance criterion. In certain embodiments, one or more of the relevance criteria may correspond to parameters of the received request for information. As a result, a particular individual relevance score determined by comparing the processed data set to a particular relevance criterion may reflect the degree to which the processed data set (and, by association, the first data source 112 from which the data set was collected) corresponds to the request parameter corresponding to the particular relevance criterion. For example, in embodiments in which the received request for information includes parameters corresponding to language (e.g., English), timeliness (e.g., within the last year), and entities (e.g., the United State Army), the processed data set may be compared with a language relevance criteria (to determine the degree to which the processed data set includes information in the English language), a timeliness relevance criteria (to determine the degree to which the processed data set includes information from within the last year), an entities relevance criteria (to determine the degree to which the processed data set includes information related to the United States Army).

Although data collection application 120 is described as comparing the processed data set with particular relevance criteria, the present invention contemplates data collection application 120 comparing the processed data set with any suitable relevance criteria (any number of which may correspond to parameters of a received request for information), according to particular needs.

Data collection application 120 may be operable to store the determined aggregate relevance score associated with the first data source 112 in database 106 and/or display the aggregate relevance score to a user of user system 102 (e.g., to the user that submitted the request for information or another user, such as an administrator). Database 106 may include any memory or database module and may take the form of volatile or non-volatile memory, including, without limitation, magnetic media, optical media, RAM, ROM, removable media, or any other suitable local or remote memory component. In certain embodiments, database 106 includes one or more SQL servers. Additionally or alternatively, data collection application 120 may be operable to store the determined aggregate relevance score associated with the first data source 112 in memory module 118 or at any other suitable location in system 100. The stored aggregate relevance score associated with the first data source 112 may be accessed later by data collection application 120 and used to determine a first data source 112 associated with a future request for information (as described above) or to determine a next data source during collection of information in response to a future request for information (as described below).

Data collection application 120 may be further operable to determine a next data source 112 from which additional information responsive to the request for information will be collected. Data collection application 120 may determine the next data source 112 by selecting from among a number of next data sources 112 accessible via the first data source 112. For example, in embodiments in which the first data source 112 is a web page, data collection application 120 may determine a next web page by selecting from among web pages accessible via the first web page (e.g., as hyperlinks displayed on the first web page). Additionally, in selecting the next data source 112 from among data sources 112 accessible via the first data source 112, data collection application 120 may account for previously determined relevance scores associated with the data sources 112 accessible via the first data source 112 (i.e., determined by data collection application 120 in response to a previous request for information). As a result, the determined next data source 112 may be the data source 112, selected from data sources 112 accessible via the first data source 112, that is most likely to include information responsive to the received request for information, thereby reducing the likelihood that large amount of irrelevant information will be collected.

Alternatively, data collection application 120 may determine a next data source 112 in response to user input (e.g., a user monitoring the data collection process may specify the next data source 112), in the manner described above with regard to determining the first data source 112, or in any other suitable manner, according to particular needs.

Data collection application 120 may be operable to initiate collection of a data set from the determined next data source 112, process the collected data set, and determine an aggregate relevance score associated with the next data source 112 in a manner substantially similar to that described above with regard to the first data source 112. By continuing in this fashion (e.g., until a predetermined time period expires, a user terminates the data collection process, or the data collection process is terminated in any other suitable manner), data collection application 120 may compile information from a number of data sources 112 containing information likely to be relevant to the received request for information. Additionally, data collection application 120 may compile aggregate relevance scores associated with each of the number of data sources 112. Once compiled, all or a part of the data sets collected from each data source 112 may be displayed to a user in response to the request for information. Moreover, the information may be displayed to the user is an order corresponding to the determined aggregate relevance scores such that information most likely to be responsive to the request for information is displayed first (or in an otherwise prominent manner).

The above-discussed functionality associated with system 100 may facilitate the collection of information from sources likely to include information relevant to a particular user while reducing or eliminating the collection of large amount of irrelevant information. As one particular example, system 100 may facilitate the collection of content from web pages (i.e., data sources 112) accessible via the Internet (i.e., network 108) in response to the receipt of a query request (i.e., a request for information) from a user of user system 102. Because the content collected from each web-page is processed using NLP and analyzed using multi-parameter relevance scoring (certain parameters of which may be related to the query received from the user), system 100 may facilitate the display of the collected content in a manner in which the content most likely to be relevant to the user is displayed first. Furthermore, because previously determined aggregate relevance scores (e.g., scores determined in response to previous queries that are the same or similar to the current query) may be used in determining those web pages from which content is collected, system 100 may facilitate the collection of information from those sources most relevant to the user's query. As a result, the collection of massive amount of irrelevant data may be reduced or eliminated, thereby reducing the time it takes to process the user's query.

Although a particular number components of system 100 have been illustrated and primarily described, the present invention contemplates system 100 including any suitable number of such components. Additionally, the functionality described above as being associated with particular components of system 100 may be combined/divided among and suitable number of components, according to particular needs. Furthermore, the various components of system 100 described above may be local or remote from one another and may be implemented in any suitable combination of hardware, firmware, and software.

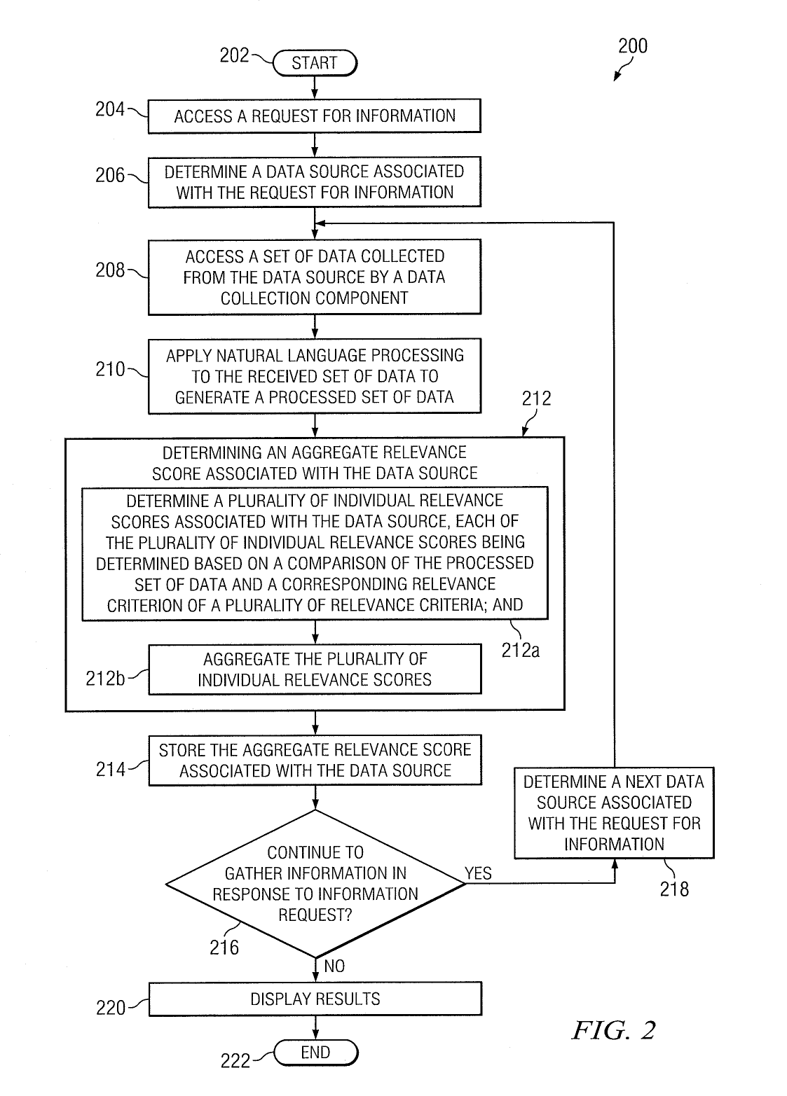

FIG. 2 illustrates an example method 200 for relevance-based OSINT collection, according to certain embodiments of the present invention. The method begins at step 202. At step 204, data collection component 120 may access a request for information. For example, data collection component may receive the request from a user of user system 102. At step 206, data collection application 120 may determine a first data source 112 (e.g., a web page) associated with the received request for information. In certain embodiments, data collection application 120 determines the first data source 112 by comparing the received request for information with previous aggregate relevance scores associated with one or more data sources 112 (e.g., accessed from memory module 118, database 106, or any other suitable location within system 100). As an example, the previous aggregate relevance scores may have been determined by data collection application 120 in response to previous requests for information. In certain other embodiments, data collection application 120 determines first data source 112 based on user input (e.g., the user may specify the first data source), based on the request for information (e.g., the request for information may identify the first data source, which may have been specified by the user), or in any other suitable manner, according to particular needs.

At step 208, data collection application 120 may access a data set (e.g., web page content) collected from a first data source 112. The accessed data set may have been collected from first data source 112 by data collection component 110. At step 210, data collection application 120 may apply NLP to the received first data set to generate a processed first data set. For example, data collection application 120 may process the first data set using NLP by performing a computational, linguistic analysis (e.g., using dictionaries, rules, pattern matching, etc.) on the data set to generate a processed data set. For example, the processed data set may include document enriched metadata associated with the data set.

At step 212, data collection application 120 may determine an aggregate relevance score associated with the first data source 112. As just one example, steps 212a-212b provide a technique by which data collection application 120 may determine an aggregate relevance score associated with the first data source 112.

At step 212a, data collection application 120 may determine a number of individual relevance scores associated with the first data source 112. Each individual relevance score may be determined based on a comparison of a particular relevance criterion among a number of relevance criteria and the processed data set. In certain embodiments, one or more of the relevance criteria may correspond to parameters of the accessed request for information. As a result, a particular individual relevance score determined by comparing the processed data set to a particular relevance criterion may reflect the degree to which the processed data set (and, by association, the first data source 112 from which the data set was collected) corresponds to the request parameter corresponding to the particular relevance criterion. For example, in embodiments in which the accessed request for information includes parameters corresponding to language (e.g., English), timeliness (e.g., within the last year), and entities (e.g., the United State Army), the processed data set may be compared with a language relevance criteria (to determine the degree to which the processed data set includes information in the English language), a timeliness relevance criteria (to determine the degree to which the processed data set includes information from within the last year), an entities relevance criteria (to determine the degree to which the processed data set includes information related to the United States Army).

At step 212b, data collection application 120 may aggregate the individual relevance scores to determine the aggregate relevance score associated with the first data source 112. For example, data collection application 120 may aggregate the individual relevance scores using a simple summation, a weighted summation, or any other suitable aggregation technique. At step 214, data collection application 120 may store the aggregate relevance score associated with first data source 112 (e.g., in database 106, memory module 118, or at any other suitable location within system 100).

At step 216, data collection application 120 may determine whether to continue to gather information in response to the accessed request for information. In certain embodiments, this determination is based on whether or not a predetermined amount of time has expired. In certain other embodiments, the determination is based on user input (i.e., input from a user indicating whether data collection should continue) or is made in any other suitable manner.

If data collection application 120 determines that it should continue to gather information, the method may proceed to step 218. At step 218, data collection application 120 may determine a next data source 120 associated with the request for information. For example, data collection application 120 may determine the next data source 112 by selecting from among a number of next data sources 112 accessible via the first data source 112. The selection of the next data source 112 from among a number of next data sources 112 accessible via the first data source 112 may be made based on previously determined relevance scores associated with the number of data sources 112, based on user input, or made in any other suitable manner. Additionally, or alternatively, data collection application 120 may determine a next data source 112 in response to user input (e.g., a user monitoring the data collection process may specify the next data source 112), in the manner described above with regard to determining the first data source 112, or in any other suitable manner, according to particular needs. Having determined the next data source 112, the method may return to step 208 where a data set is received from the next data source 112 and the method proceeds as described above.

Returning to step 216, if data collection application 120 determines that it should not continue to gather information, the method may proceed to step 220. At step 220, data collection application 120 may display results to a user of user system 102. The displayed results may include all or a portion of the data sets collected from each data source 112, the aggregate relevance score associated with each data source 112 from which the data sets were collected, and/or any other suitable information according to particular needs. Additionally, the data sets collected from each data source 112 may be displayed to the user in an order corresponding to the aggregate relevance scores associated with each data source 112 (such that the most relevant information is displayed first or in an otherwise prominent manner). The method may end at step 222.

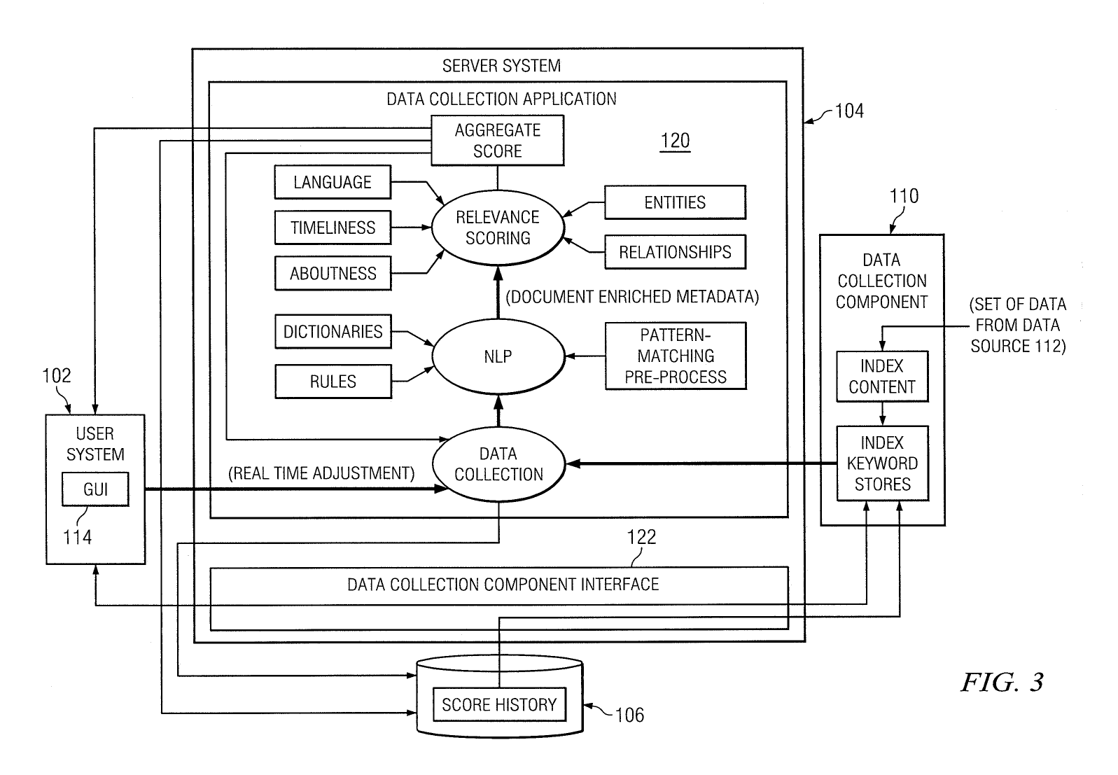

FIG. 3 illustrates example functions performed by certain components of system 100 (described above with regard to FIG. 1) during OSINT intelligence collection, according to certain embodiments of the present invention. Although certain components of system 100 are not depicted for simplicity, the present invention contemplates those components as being involved in the OSINT intelligence collection in a manner substantially similar to that described above with regard to FIGS. 1-2.

Data collection component 110 (e.g., a web crawler) may be operable to collect a data set from a data source 112. Having collected the data set from the data source 112, data collection component may index the content and index keyword stores associated with the content prior to communicating the content (via network 108, not depicted) to data collection application 120 of server system 104. Data collection application 120 may access (e.g., receive) the collected data set and store the data set in database 108. Additionally, a real time view of the data received may be provided to a user of user system 102 such that the user can provide real time adjustments regarding the data sets being collected. For example, the user may choose to discard the data before further processing if the data is viewed as not relevant to the request for information. Additionally or alternatively, the user may provide real time feedback by providing direction to data collection component 110 (via data collection component interface 122) regarding which data sources 112 the user believes to be more likely to contain information relevant to the request for information.

Data collection application 120 may perform NLP on the collected data set (e.g., by performing a computational, linguistic analysis using dictionaries, rules, pattern matching, etc.) to generate document enriched metadata. An aggregate relevance score associated with the document enriched metadata may be determined by aggregating a number of individual relevance scores. Each individual relevance score may be determined based on a comparison of the document enriched metadata with one or a number of relevance criteria (e.g., language, timeliness, aboutness, entities, and relationships).

Data collection application 120 may store the aggregate relevance score in database 106. The score may be stored in association with the previously stored data set received from data collection component 110 such that all or a portion of the data set (along with a number of other data sets) may later display to a user is an order corresponding to the aggregate relevance scores associated with each of the data sets. Additionally or alternatively, the score may be stored in a score history associated with the parameters of the request for information in response to which the data set was collected from the data source 112. In certain embodiments, the score history is additionally provided to data collection component 110 via data collection component interface 122.

The score history may include a compilation of aggregate relevance scores associated with a number of data sources 112 from which data sets are collected in response to a request for information. As a result, if a future request for information having the same or similar parameters is received, data collection application 120 (and/or data collection component 110) may utilize the score history in order to determine those information sources likely to include information responsive to the subsequent request for information. This may prevent the collection of massive amount of irrelevant data and reduce the time it takes to process the subsequent request for information.

Additionally, the determined aggregate relevance score may be displayed to a user of user system 102. The aggregate relevance score may assist the user in providing real time feedback in that the user may provide direction to data collection component 110 (via data collection component interface 122) based on the displayed score. For example, if the user believes that the determined score is too low, the user may direct data collection component 110 to a new data source that the user believes to be more likely to contain information relevant to the request for information.

Data collection component 110 may then be directed to a next data source (e.g., a data source 112 accessible via the previous data source 112). The next data source may be determined based on score histories associated with previous request for information (the score histories being accessed by data collection component 110 from database 106 via data collection component interface 122 or otherwise provided to data collection component 110 in any other suitable manner). Alternatively, the next data source 112 may be determined based on real time feedback received from a user.

When the data collection process is complete, all or a portion of the collected sets of information may be displayed to a user of user system 102. In certain embodiments, the data sets may be displayed in an order corresponding to the aggregate relevance scores associated with the data sources 112 from which the data sets were collected.

In certain embodiments, certain of the above described components of system 100 (e.g., data collection application 120, data collection component interface 122, and or data collection component 110) may be implemented in the form of a computer-readable medium encoded with software operable to perform all or a portion of the functionality described herein.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A method for relevance-based open source intelligence (OSINT) collection, comprising:
accessing a request for information;
determining a first web page associated with the request for information;
accessing first web page content collected from the first web page by a web crawler;
applying natural language processing to the first web page content to generate processed first web page content;
determining an aggregate relevance score associated with the first web page by:
determining a plurality of individual relevance scores associated with the first web page, each of the plurality of individual relevance scores being determined based on a comparison of the processed first web page content and a corresponding relevance criterion of a plurality of relevance criteria; and
aggregating the plurality of individual relevance scores, the aggregate relevance score associated with the first web page being the aggregation of the plurality of individual relevance scores associated with the first web page; and
storing the aggregate relevance score associated with the first web page.

2. The method of claim 1, comprising:
determining a second web page associated with the request for information;
accessing second web page content collected from the second web page by the web crawler;
applying natural language processing to the second web page content to generate processed second web page content;
determining an aggregate relevance score associated with the second web page by:
determining a plurality of individual relevance scores associated with the second web page, each of the plurality of individual relevance scores being determined based on a comparison of the processed second web page content and a corresponding relevance criterion of the plurality of relevance criteria; and
aggregating the plurality of individual relevance scores, the aggregate relevance score associated with the second web page being the aggregation of the plurality of individual relevance scores associated with the second web page; and
storing the aggregate relevance score associated with the second web page.

3. The method of claim 2, wherein the second web page is accessible via the first web page as a hyperlink displayed on the first web page.

4. The method of claim 2, wherein determining the second web page associated with the request for information comprises selecting the second web page from among a plurality of web pages, the selection being based on previous aggregate relevance scores associated with one or more of the plurality of web pages.

5. The method of claim 2, wherein determining the second web page associated with the request for information comprises selecting the second web page from among a plurality of web pages, the selection being based on user input specifying the second web page.

6. A method for relevance-based open source intelligence (OSINT) collection, comprising:
accessing a request for information;
determining a first data source associated with the request for information;
accessing a first data set collected from the first data source by a data collection component;
applying natural language processing to the first data set to generate a processed first data set;
determining an aggregate relevance score associated with the first data source by:
determining a plurality of individual relevance scores associated with the first data source, each of the plurality of individual relevance scores being determined based on a comparison of the processed first data set and a corresponding relevance criterion of a plurality of relevance criteria; and
aggregating the plurality of individual relevance scores, the aggregate relevance score associated with the first data source being the aggregation of the plurality of individual relevance scores associated with the first data source; and
storing the aggregate relevance score associated with the first data source.

7. The method of claim 6, comprising:
determining a second data source associated with the request for information;
accessing a second data set collected from the second data source by the data collection component;
applying natural language processing to the second data set to generate a processed second data set;
determining an aggregate relevance score associated with the second data source by:
determining a plurality of individual relevance scores associated with the second data source, each of the plurality of individual relevance scores being determined based on a comparison of the processed second data set and a corresponding relevance criterion of the plurality of relevance criteria; and
aggregating the plurality of individual relevance scores, the aggregate relevance score associated with the second data source being the aggregation of the plurality of individual relevance scores associated with the second data source; and
storing the aggregate relevance score associated with the second data source.

8. The method of claim 7, wherein the second data source is accessible via the first data source.

9. The method of claim 7, wherein determining the second data source associated with the request for information comprises selecting the second data source from among a plurality of data sources, the selection being based on previous aggregate relevance scores associated with one or more of the plurality of data sources.

10. The method of claim 7, wherein determining the second data source associated with the request for information comprises selecting the second data source from among a plurality of data sources, the selection being based on user input specifying the second data source.

11. The method of claim 7, wherein:
the first data source comprises a first web page; and
the second data source comprises a second web page.

12. The method of claim 7, comprising displaying to a user information associated with the first and second data sources, the information being displayed in an order corresponding to the aggregate scores associated with the first and second data sources.

13. The method of claim 6, wherein the data collection component comprises a web crawler.

14. The method of claim 6, wherein:
the request for information comprises a plurality of request parameters; and
a particular relevance criterion of the plurality of relevance criteria corresponds to a particular request parameter of the plurality of request parameters.

15. A system for relevance-based open source intelligence (OSINT) collection, comprising:
one or more processing units operable to:
access a request for information;
determine a first data source associated with the request for information;
access a first data set collected from the first data source by a data collection component;
apply natural language processing to the first data set to generate a processed first data set;
determine an aggregate relevance score associated with the first data source by:
determining a plurality of individual relevance scores associated with the first data source, each of the plurality of individual relevance scores being determined based on a comparison of the processed first data set and a corresponding relevance criterion of a plurality of relevance criteria; and
aggregating the plurality of individual relevance scores, the aggregate relevance score associated with the first data source being the aggregation of the plurality of individual relevance scores associated with the first data source; and
store the aggregate relevance score associated with the first data source.

16. The system of claim 15, wherein the one or more processing units are further operable to:
determine a second data source associated with the request for information;
access a second data set collected from the second data source by the data collection component;
apply natural language processing to the second data set to generate a processed second data set;
determine an aggregate relevance score associated with the second data source by:
determining a plurality of individual relevance scores associated with the second data source, each of the plurality of individual relevance scores being determined based on a comparison of the processed second data set and a corresponding relevance criterion of the plurality of relevance criteria; and
aggregating the plurality of individual relevance scores, the aggregate relevance score associated with the second data source being the aggregation of the plurality of individual relevance scores associated with the second data source; and
store the aggregate relevance score associated with the second data source.

17. The system of claim 16, wherein the second data source is accessible via the first data source.

18. The method of claim 16, wherein determining the second data source associated with the request for information comprises selecting the second data source from among a plurality of data sources, the selection being based on previous aggregate relevance scores associated with one or more of the plurality of data sources.

19. The system of claim 16, wherein determining the second data source associated with the request for information comprises selecting the second data source from among a plurality of data sources, the selection being based on user input specifying the second data source.

20. The system of claim 16, wherein:
the first data source comprises a first web page; and
the second data source comprises a second web page.

21. The system of claim 7, wherein the one or more processing units are further operable to display to a user information associated with the first and second data sources, the information being displayed in an order corresponding to the aggregate scores associated with the first and second data sources.

22. The system of claim 15, wherein the data collection component comprises a web crawler.

23. The system of claim 15, wherein:
the request for information comprises a plurality of request parameters; and
a particular relevance criterion of the plurality of relevance criteria corresponds to a particular request parameter of the plurality of request parameters.
